(19) United States
(12) Patent Application Publication
(10) Pub. No.: US 2026/0219607 A1
(43) Pub. Date: Jul. 30, 2026

(54) IMAGE FORMING APPARATUS

(71) Applicant: SHARP KABUSHIKI KAISHA, Osaka (JP)

(72) Inventors: Takahiro TAGUCHI, Osaka (JP); Kouta Yoshikawa, Osaka (JP); Yuusuke Itagaki, Osaka (JP)

(21) Appl. No.: 19/456,139

(22) Filed: Jan. 22, 2026

(30) Foreign Application Priority Data
Jan. 30, 2025 (JP) 2025-014005

(51) Int. Cl. G03G 15/20; G03G 21/16

(52) U.S. Cl. CPC G03G 15/2035; G03G 15/2064; G03G 21/1633; G03G 21/1685; G03G 2221/1639; G03G 2221/1654

(57) ABSTRACT

An image forming apparatus includes a fixing device that includes a switching member capable of switching between a pressurization state in which a pressurization member is pressurized against a rotatable fixing member and a pressurization-release state, and an access member. The switching member is movable between an open/closed-state pressurization possible position where the pressurization member is capable of being in the pressurization state regardless of opening/closing of the access member, and an open-state pressurization-release possible position where the pressurization member is capable of being in the pressurization-release state when the access member is open but is not capable of being in the pressurization-release state when the access member is closed. The switching member is further movable to an open/closed-state pressure-release possible position at which the pressurization member is capable of being in the pressurization-release state regardless of opening/closing of the access member.

### CROSS-REFERENCE TO RELATED APPLICATION

The present application claims priority from Japanese Application JP2025-014005, the content of which is hereby incorporated by reference into this application.

### BACKGROUND OF THE INVENTION

### 1. Field of the Invention

The present disclosure relates to an image forming apparatus such as a copier, a multifunction peripheral, a printer, and a facsimile machine.

### 2. Description of the Related Art

As a known technique, there is known an image forming apparatus including a fixing device (fixing unit) having a switching member (release lever) capable of switching between a pressurization state in which a pressurization member (press roller) is pressed against a rotatable fixing member (heat roller) and a pressurization-release state in which the pressurization state of the pressurization member is released, and an access member (jam access cover) that covers the fixing device in a closed state and exposes the fixing device in an open state.

Specifically, as a known technique, there is known a configuration in which the switching member is movable between an open/closed-state pressurization possible position where the pressurization member can be in the pressurization state regardless of opening and closing of the access member and an open-state pressurization-release possible position where the pressurization member can be in the pressurization-release state when the access member is open and the pressurization member cannot be in the pressurization-release state when the access member is closed.

### SUMMARY OF THE INVENTION

In such a known image forming apparatus, when an operator closes the access member, the pressurization member cannot be brought into the pressurization-release state with respect to the fixing member, and the pressurization member is always in the pressurization state. Therefore, in the case where the transportation and/or storage of the image forming apparatus at the time of shipment is prolonged, or in the case where the image forming apparatus does not perform an image forming operation (printing operation) over a long period of time even after installation, the fixing member (for example, a fixing belt or a fixing roller) and/or the pressurization member (for example, a pressure roller) may become plastically deformed at the fixing nip portion (contact portion), and this may affect the image quality. This leads to a decrease in image quality.

In view of the above, an object of an aspect of the present disclosure is to provide an image forming apparatus that is capable of bringing a pressurization member into a pressurization-release state with respect to a fixing member even in a state where an operator closes an access member.

In order to solve the problem, an image forming apparatus according to an aspect of the present disclosure includes a fixing device that includes a switching member capable of switching between a pressurization state in which a pressurization member is pressurized with respect to a rotatable fixing member and a pressurization-release state in which the pressurization state of the pressurization member is released, and an access member that covers the fixing device in a closed state and exposes the fixing device in an opened state, wherein the switching member is movable between an open/closed-state pressurization possible position where the pressurization member is capable of being in the pressurization state regardless of opening/closing of the access member, and an open-state pressurization-release possible position where the pressurization member is capable of being in the pressurization-release state when the access member is open but is not capable of being in the pressurization-release state when the access member is closed, and the switching member is further movable to an open/closed-state pressure-release possible position at which the pressurization member is capable of being in the pressurization-release state regardless of opening/closing of the access member.

According to an aspect of the present disclosure, even in a state where an operator closes the access member, the pressurization member can be brought into the pressurization-release state with respect to the fixing member, so that it is possible to effectively prevent deterioration in image quality due to plastic deformation of the fixing member and/or the pressurization member.

### BRIEF DESCRIPTION OF THE DRAWINGS

FIG. 1 is a cross-sectional view of an image forming apparatus according to an embodiment of the disclosure.

FIG. 2 is a perspective view of a fixing device in the image forming apparatus illustrated in FIG. 1.

FIG. 3 is a cross-sectional view of the fixing device illustrated in FIG. 2 taken along line A-A.

FIG. 4 is a cross-sectional view of the fixing device illustrated in FIG. 2 taken along line B-B.

FIG. 5 is a perspective view illustrating a closed state of a first access member in the image forming apparatus illustrated in FIG. 1 together with the first access member in an open state.

FIG. 6 is a perspective view of the image forming apparatus illustrated in FIG. 1 from which the first access member is detached.

FIG. 7 is a perspective view of a switching mechanism in the fixing device illustrated in FIG. 1.

FIG. 8 is an exploded perspective view of the switching mechanism on the right side in the fixing device illustrated in FIG. 1.

FIG. 9 is an exploded perspective view of the switching mechanism on the left side in the fixing device illustrated in FIG. 1.

FIG. 10 is a perspective view of the fixing device illustrated in FIG. 1 in which a pressurization member is in a pressurization-release state.

FIG. 11 is an enlarged perspective view of an inner side surface of the first access member illustrated in FIG. 6.

FIG. 12 is a perspective view of a switching member.

FIG. 13 is a perspective view of a switching turning shaft.

FIG. 14 is a cross-sectional view of the fixing device in which the switching member is located at the open/closed-state pressurization possible position.

FIG. 15 is a cross-sectional view of the fixing device in which the switching member is located at the open-state pressurization-release possible position.

FIG. 16 is a cross-sectional view of the fixing device in which the switching member is located at the open/closed-state pressure-release possible position.

FIG. 17 is a cross-sectional view of the fixing device in which the switching member is located at a slidable position.

FIG. 18 is a cross-sectional view showing a state in which an inclined surface of the switching member is in sliding contact with the pressing member.

FIG. 19 is a cross-sectional view illustrating a state in which a fixing member is inserted between the switching member and the bottom plate of the fixing device.

### DETAILED DESCRIPTION OF THE INVENTION

Embodiments according to the present disclosure will be described below with reference to the drawings. In the following description, the same components are denoted by the same reference numerals. Their names and functions are also the same. Accordingly, detailed descriptions thereof will not be repeated.

### Image Forming Apparatus

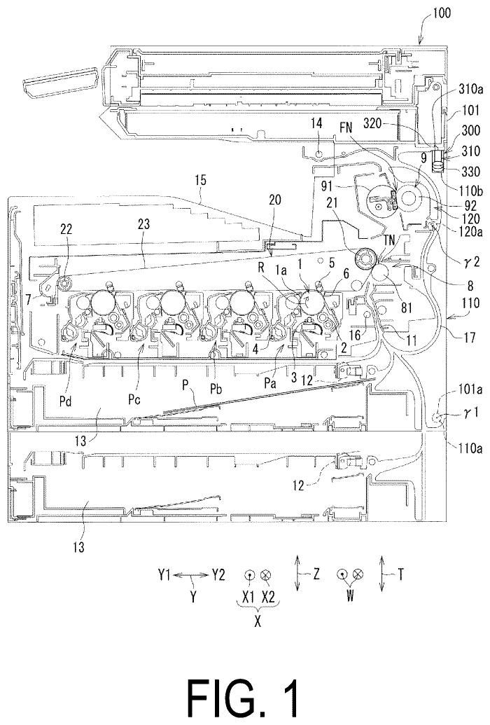

FIG. 1 is a cross-sectional view of an image forming apparatus 100 according to an embodiment of the disclosure. The following description will be given based on designations in the drawings in which the width direction is denoted as X, the right side as X1, the left side as X2, the direction orthogonal to the width direction X as the depth direction Y, the front surface side as Y1, the rear side as Y2, and the vertical direction orthogonal to both the width direction X and the depth direction Y as Z.

The image data used in an image forming apparatus body 101 of the image forming apparatus 100 corresponds to either a color image using each of the colors black (K), cyan (C), magenta (M), and yellow (Y), or a monochrome image using a single color (for example, black). In this manner, a photoreceptor drum 1 (scanned member, image carrier), a charger 2, a print head 3 (exposure device), a development device 4, a primary transfer device 5 and a drum cleaning device 6 are each provided in four units to form four types of toner images of respective colors. These components are respectively associated with black, cyan, magenta, and yellow, thereby forming four image stations Pa, Pb, Pc, and Pd. Note that the image forming apparatus 100 may be a monochrome image forming apparatus.

At the image stations Pa, Pb, Pc, and Pd, the chargers 2 to 2 uniformly charge, to a predetermined potential, surfaces 1a of the photoreceptor drums 1 to 1 rotationally driven in a predetermined rotational direction R. The print heads 3 to 3 expose the surfaces 1a of the photoreceptor drums 1 to 1 to form electrostatic latent images on the surfaces 1a of the photoreceptor drums 1 to 1. The development devices 4 develop the electrostatic latent images on the surfaces 1a of the photoreceptor drums 1 to 1 to form toner images on the surfaces 1a of the photoreceptor drums 1 to 1. Thus, the toner images of the respective colors are formed on the surfaces 1a of the photoreceptor drums 1 to 1. The drum cleaning devices 6 to 6 remove and collect the residual toner on the surfaces 1a of the photoreceptor drums 1 to 1. The primary transfer devices 5 to 5 sequentially superimpose and transfer the color toner images on the surfaces 1a of the photoreceptor drums 1 to 1 to an intermediate transfer belt 23 circulated by a driving roller 21 and a driven roller 22 of a belt drive device 20, thereby forming color toner images on the intermediate transfer belt 23. A belt cleaning device 7 removes and collects the residual toner on the intermediate transfer belt 23.

A transfer nip portion TN is formed between the intermediate transfer belt 23 and a transfer roller 81 of a secondary transfer device 8. The transfer roller 81 of the secondary transfer device 8 conveys a sheet P such as recording sheet or the like that has been conveyed through a sheet conveyance path 11 together with the intermediate transfer belt 23 by sandwiching the sheet P at the transfer nip portion TN, while transferring the color toner images on the surface of the intermediate transfer belt 23 onto the sheet P. A fixing device 9 fixes the color toner image on the sheet P by applying heat and pressure with the sheet P sandwiched between a fixing member 91 (in this example, a fixing belt) and a pressurization member 92 (in this example, a pressure roller).

The image forming apparatus 100 conveys to the sheet conveyance path 11 the sheet P drawn from a sheet feeder 13 (sheet feeding cassette) by a pickup roller 12, and conveys the sheet P toward a discharge roller 14 through the secondary transfer device 8 and the fixing device 9. The image forming apparatus 100 ejects the sheet P conveyed to the discharge roller 14, to a discharge tray 15 by means of the discharge roller 14. A registration roller 16 and the like are disposed in the sheet conveyance path 11. The registration roller 16 temporarily stops the sheet P and aligns the leading end of the sheet P, and then starts the conveyance of the sheet P in synchronization with the transfer timing for the toner image at the transfer nip portion TN between the intermediate transfer belt 23 and the transfer roller 81.

Note that, in FIG. 1, the sheet feeder 13 is provided in two stages, but this is not limitative, and the sheet feeder 13 may be provided in one stage, or three or more stages.

In addition, in a case where the image forming apparatus 100 forms images not only on the front surface but also on the rear surface of the sheet P, the image forming apparatus 100 conveys the sheet P in the reverse direction from the discharge roller 14 to a sheet inversion feeding path 17. The image forming apparatus 100 conveys, toward the sheet inversion feeding path 17, the sheet P conveyed in the reverse direction, reverses the sheet P upside down by means of the sheet inversion feeding path 17, and guides the sheet P to the registration roller 16 again. The image forming apparatus 100 forms images on the rear surface of the sheet P guided to the registration roller 16 as on the front surface, and ejects it to the discharge tray 15.

### Fixing Device

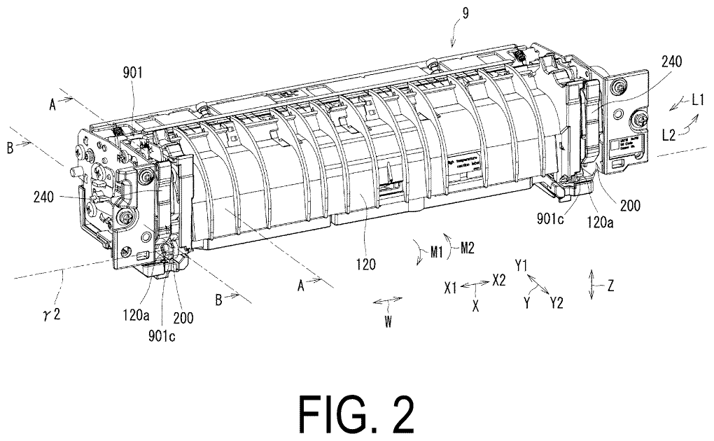

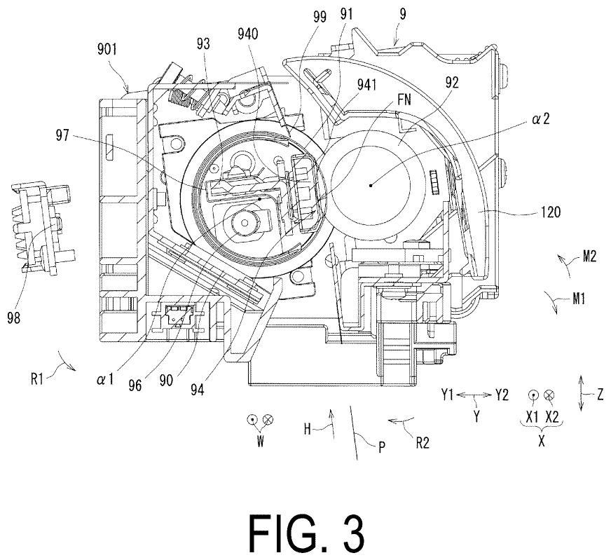

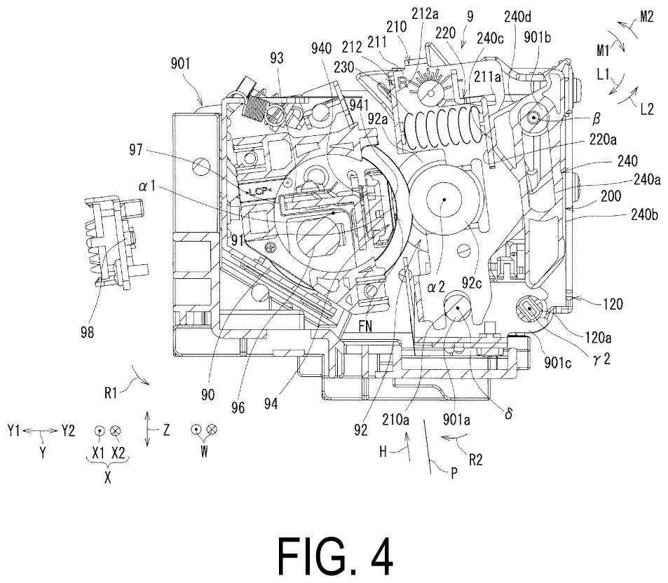

FIG. 2 is a perspective view of the fixing device 9 in the image forming apparatus 100 illustrated in FIG. 1. FIGS. 3 and 4 are cross-sectional views of the fixing device 9 illustrated in FIG. 2 taken along the line A-A and line B-B, respectively.

The fixing device 9 further includes a support member 93, a fixing pad 94, a heat source 96, a reflection member 97 (in this example, a reflection plate), a temperature detection unit 98 (in this example, a thermopile), a separation plate 99 (see FIG. 3) and a thermostat 90. The support member 93, the fixing pad 94, the heat source 96 and the reflection member 97 are provided inside a fixing belt (91).

The fixing belt (91) is an endless (annular) flexible belt. The fixing belt (91) is rotatable around a rotation axis α1 extending along an orthogonal direction (width direction X) orthogonal to a transport direction H of the sheet P.

The fixing pad 94 is composed of resin and is formed in a long plate shape extending in a rotation axis direction W of the fixing belt (91), for example. The fixing pad 94 includes a fixing pad body 940, and a slide movement sheet 941 provided on the surface of the fixing pad body 940 on the side that makes sliding contact with the fixing belt (91).

The support member 93 supports the fixing pad 94. The support member 93 is fixed to a fixing device body 901 (main body frame) at both end portions in the rotation axis direction W. The reflection member 97 is provided on at least the surface of the support member 93 on the heat source 96 side.

The heat source 96 is a member for heating the fixing belt (91), and extends in the rotation axis direction W of the fixing belt (91). The heat source 96 may be a lamp heater such as a halogen lamp, for example.

A pressure roller (92) is disposed at a position facing the fixing pad 94 with the fixing belt (91) sandwiched therebetween. The pressure roller (92) rotates around a rotation axis α2 that is parallel to the rotation axis α1 of the fixing belt (91), and extends parallel to the fixing belt (91). The pressure roller (92) presses the fixing belt (91) toward the fixing pad 94, and forms a fixing nip portion FN between the pressure roller (92) and the fixing belt (91).

The driving force from a driving source (not illustrated) such as a motor is transmitted to the pressure roller (92) through a drive transmission mechanism (not illustrated) such as a gear. The pressure roller (92) is driven into rotation with the driving force from the driving source. The fixing belt (91) rotates to follow the rotation of the pressure roller (92) in a first rotational direction R1 that is opposite to a second rotational direction R2 of the pressure roller (92) direction.

The image forming apparatus 100 includes a first access member 110 (in this example, a rear access door) (see FIG. 1), and the fixing device 9 includes a second access member 120 (in this example, a conveyance paper guide).

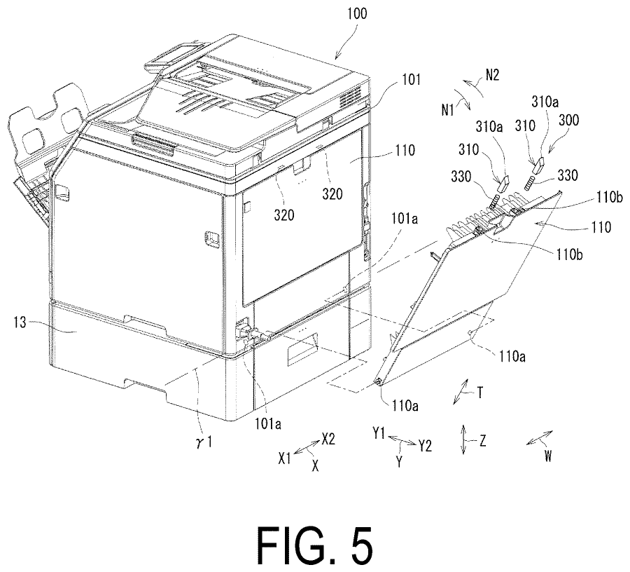

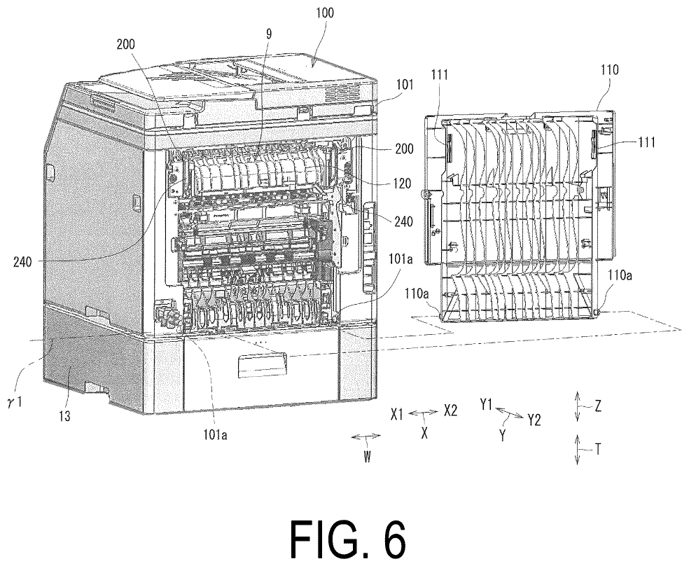

FIG. 5 is a perspective view illustrating a closed state of the first access member 110 in the image forming apparatus 100 illustrated in FIG. 1 together with the first access member 110 in an opened state. FIG. 6 is a perspective view illustrating a state where the first access member 110 is detached from the image forming apparatus 100 illustrated in FIG. 1.

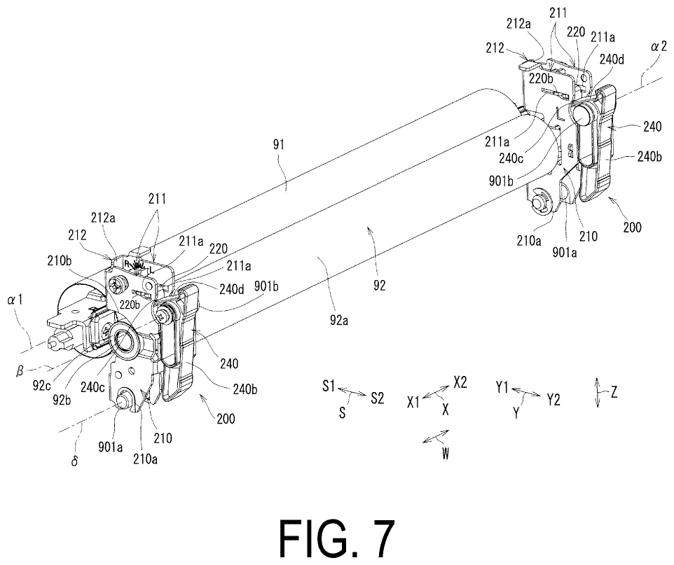

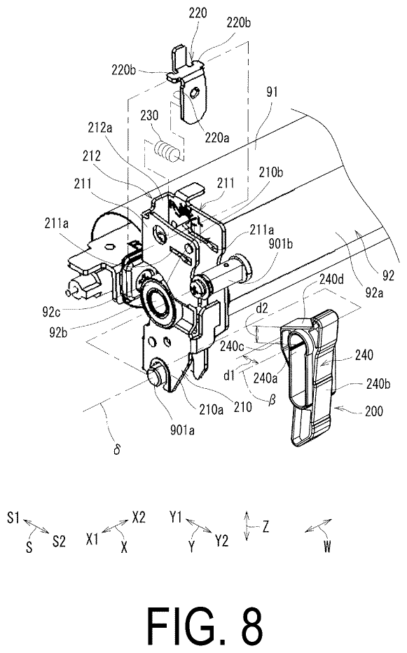

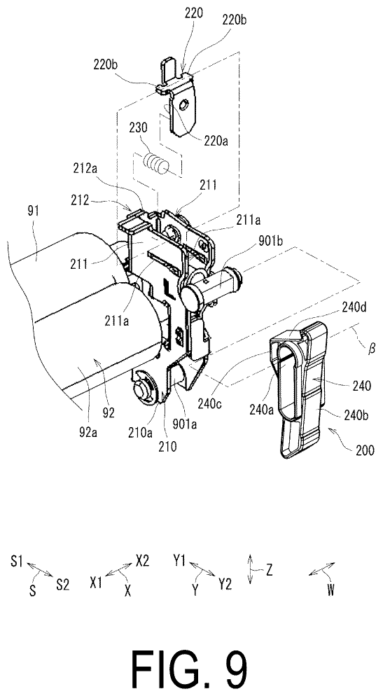

FIG. 7 is a perspective view illustrating a switching mechanism 200 in the fixing device 9 illustrated in FIG. 1. FIGS. 8 and 9 are exploded perspective views illustrating the switching mechanisms 200 on the right side and left side in the fixing device 9 illustrated in FIG. 1, respectively.

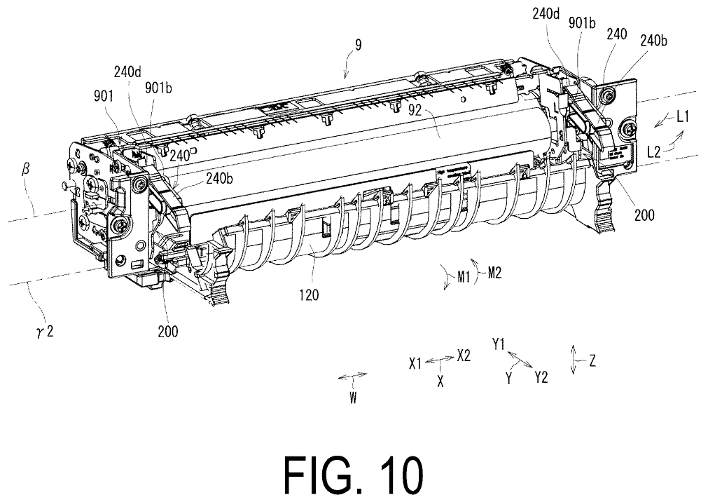

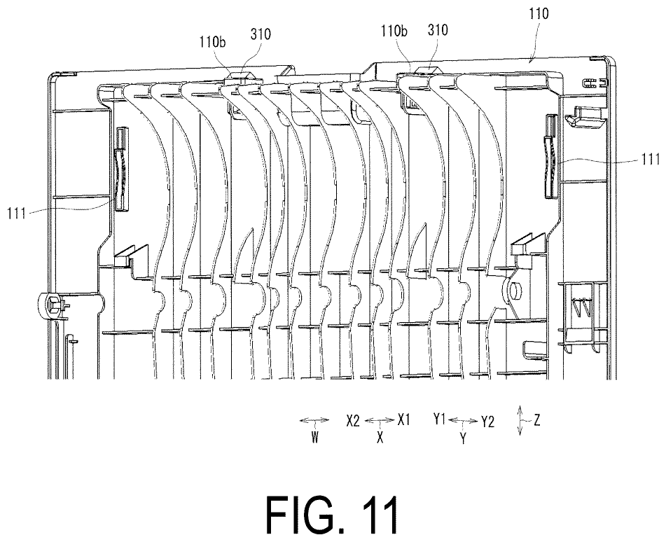

FIG. 10 is a perspective view of the fixing device 9 illustrated in FIG. 1 in which the pressurization member 92 is in a pressurization-release state. FIG. 11 is an enlarged perspective view of an inner side surface of the first access member 110 illustrated in FIG. 6.

### Switching Mechanism

The fixing device 9 includes the switching mechanism 200 including a switching member 240 (240, 240) capable of switching between a pressurization state in which the pressurization member 92 is pressed against the rotatable fixing member 91 and a pressurization-release state in which the pressurization state of the pressurization member 92 is released. In this example, the switching mechanism 200 is a pair of the switching mechanisms 200, 200 provided at both end portions in the rotation axis direction W. The pair of the switching mechanisms 200, 200 each includes a support member 210, a pressing member 220, a biasing member 230 (in this example, a coil spring), and the switching member 240. Specifically, the support member 210 is a pair of the support members 210, 210, the pressing member 220 is a pair of the pressing members 220, 220, the biasing member 230 is a pair of the biasing members 230, 230, and the switching member 240 is a pair of the switching members 240, 240.

The support members 210, 210 freely support the pressurization member 92 so as to be movable toward and away from the fixing member 91. Specifically, the support members 210, 210 rotatably support the pressurization member 92 around the rotation axis α2 (see FIG. 3), and sway it about a sway axis δ (see FIGS. 4, 7, and 8) along the rotation axis direction W with respect to the fixing device body 901. In this example, sway shafts 901a, 901a extending along the rotation axis direction W are fixed at both end portions of the fixing device body 901 in the rotation axis direction W.

The support members 210, 210 are provided with engagers 210a, 210a (engagement recessed portions) that engage with the sway shafts 901a, 901a of the fixing device body 901, and recessed portions 210b, 210b that receive rotary shafts 92b, 92b of the pressure roller (92). The pressure roller (92) is composed of a roller 92a that fixes a toner image to the sheet P, and the rotary shafts 92b, 92b provided at both end portions of the roller 92a in the rotation axis direction W. In the pressure roller (92), the rotary shafts 92b, 92b are supported at the recessed portions 210b, 210b of the support members 210, 210 through bearing members 92c, 92c (bearings). In this manner, the support members 210, 210 can support the pressurization member 92 so as to be rotatable around the rotation axis α2 and so as to be movable toward and away from the fixing member 91 about the sway axis δ.

The pressing members 220, 220 are supported with respect to the support members 210, 210 movably in an approach/separation direction S (depth direction Y in this example) of the pressurization member 92 with respect to the fixing member 91, and are biased by the biasing members 230, 230 toward a separation direction S2 in the approach/separation direction S. Specifically, the support members 210, 210 each include a pair of side plates 211, 211, and a coupling plate 212 that couples the pair of side plates 211, 211. The pair of side plates 211, 211 and the coupling plate 212 are integrally formed. Slits 211a, 211a extending along the approach/separation direction S are provided on the side opposite to the engager 210a with the recessed portions 210b, 210b of the pair of side plates 211, 211 therebetween in the radial direction of the sway axis δ.

The pressing members 220, 220 are provided with a pressing surface 220a that presses the coupling plate 212 of the support members 210, 210 through the biasing members 230, 230, and a pair of protruding portions 220b, 220b that are inserted into the slits 211a, 211a, respectively. In this manner, the support members 210, 210 can movably (slidably) support the pressing members 220, 220 in the approach/separation direction S with the pressing members 220, 220 biased to the separation direction S2 by means of the biasing members 230, 230.

The coupling plate 212 includes a contacted surface 212a that faces the pressing surface 220a in the pressing members 220, 220 and is orthogonal to the approach/separation direction S. The biasing members 230, 230 are disposed between the contacted surfaces 212a, 212a of the coupling plates 212, 212 and the pressing surfaces 220a, 220a of the pressing members 220, 220.

The switching members 240, 240 are each provided with an insertion hole 240a (see FIGS. 4 and 8), a lever 240b, an open/closed-state pressurization surface 240c, and an open-state pressurization-release surface 240d.

Switching turning shafts 901b, 901b extending along the rotation axis direction W are fixed at both end portions of the fixing device body 901 in the rotation axis direction W. The insertion holes 240a, 240a of the switching members 240, 240 are inserted into the switching turning shafts 901b, 901b of the fixing device body 901, respectively. In this manner, the switching members 240, 240 can turn about a switching turning axis β (see FIGS. 4 and 7 to 9) extending along the rotation axis α1 of the fixing member 91.

The lever 240b is grabbed by the operator. The open/closed-state pressurization surface 240c and the open-state pressurization-release surface 240d are flat surfaces along both the longitudinal direction of the lever 240b and the rotation axis direction W, and are connected such that an angle formed by the open/closed-state pressurization surface 240c and the open-state pressurization-release surface 240d is an obtuse angle. A distance d1 (see FIG. 8) between the open/closed-state pressurization surface 240c and the switching turning axis β is greater than a distance d2 (see FIG. 8) between the open-state pressurization-release surface 240d and the switching turning axis β (d1>d2).

In the switching members 240, 240, when the operator turns the lever 240b of the switching members 240, 240 in the direction that intersects the approach/separation direction S, the open/closed-state pressurization surface 240c makes contact with the pressing surface 220a in the pressing member 220. At this time, the contact of the switching member 240, 240 with the pressing surface 220a of the open/closed-state pressurization surface 240c is maintained beyond the top dead center (corner portion between the open/closed-state pressurization surface 240c and the open-state pressurization-release surface 240d) in the process of transition from the open-state pressurization-release surface 240d to the open/closed-state pressurization surface 240c. Then, pressing of the open/closed-state pressurization surface 240c in the switching members 240, 240 against the pressing surface 220a in the pressing members 220, 220 presses the coupling plate 212 in the support members 210, 210 to an approach side S1 in the approach/separation direction S against the biasing force of the biasing members 230, 230. In this manner, the pressurization member 92 can be brought into the pressurization state with respect to the fixing member 91.

In addition, in the switching members 240, 240, when the operator turns the lever 240b of the switching members 240, 240 in the approach/separation direction S, the open-state pressurization-release surface 240d makes contact with the pressing surface 220a of the pressing member 220. At this time, the contact of the switching member 240, 240 with the pressing surface 220a of the open-state pressurization-release surface 240d is maintained beyond the top dead center (corner portion between the open/closed-state pressurization surface 240c and the open-state pressurization-release surface 240d) in the process of transition from the open/closed-state pressurization surface 240c to the open-state pressurization-release surface 240d. Then, when the pressing of the open-state pressurization-release surface 240d of the switching members 240, 240 against the pressing surface 220a of the pressing members 220, 220 is released, the pressing to the coupling plate 212 in the support members 210, 210 through the biasing members 230, 230 is released. In this manner, the pressurization member 92 can set the fixing member 91 to the pressurization-release state.

In the present embodiment, as described above, the fixing device 9 can switch between the pressurization state and the pressurization-release state of the pressurization member 92 (in this example, the pressure roller) with respect to the rotatable fixing member 91 (in this example, fixing belt) by means of the switching member 240.

The first access member 110 (see FIGS. 1, 5, and 6) in the closed state covers the fixing device 9, and the first access member 110 in the opened state exposes all or part of the fixing device 9. The second access member 120 in the closed state covers the component (in this example, the pressurization member 92) in the fixing device body 901, and the second access member 120 in the opened state exposes all or part of the component (92).

Here, “rotation” refers to movement of a target member by 360 degrees or more, whereas “turning” refers to movement of the target member by less than 360 degrees.

As illustrated in FIGS. 5 and 6, the first access member 110 is provided so as to be capable of turning about the first turning axis γ1 with respect to the image forming apparatus body 101.

Specifically, a pair of engagers 101a, 101a (engagement holes) are provided in a lower portion in the image forming apparatus body 101 at the inner side surfaces in the rotation axis direction W on the upper side of the sheet feeder 13. A pair of turning support shafts 110a, 110a extending outward along the rotation axis direction W are provided at the outer side surfaces in the rotation axis direction W at the lower end portion of the first access member 110. In the first access member 110, the turning support shafts 110a, 110a respectively engage with the engagers 101a, 101a in the image forming apparatus body 101. In this manner, the first access member 110 turns about the first turning axis γ1, and can open and close with respect to the image forming apparatus body 101.

The image forming apparatus body 101 is provided with a lock mechanism 300 (see FIGS. 1 and 5) that locks the first access member 110 to the image forming apparatus body 101 in a releasable manner.

The lock mechanism 300 includes one or more (in this example, two) engagement portions 310, 310 (in this example, protruding portions) provided in the first access member 110, one or more (in this example, two) locking portions 320, 320 (in this example, recessed portions) provided in the image forming apparatus body 101 and locks the engagement portions 310, 310, and biasing members 330, 330 (coil spring).

The first access member 110 is provided with storage chambers 110b, 110b for accommodating the engagement portions 310, 310, and the biasing members 330, 330. In the storage chambers 110b, 110b, the engagement portions 310, 310 are provided so as to be movable in an approach/separation direction T (the radial direction with the first turning axis γ1 at the center) in which they move toward and away from the locking portions 320, 320. The engagement portions 310, 310 have pointed tip end portions 310a. The biasing members 330, 330 are disposed between the bottom surfaces of the storage chambers 110b, 110b and the engagement portions 310, 310, and bias the engagement portions 310, 310 to the side opposite to the first turning axis γ1 in the approach/separation direction T. Note that, the first access member 110 is provided with a removal preventing portion (omitted in the drawing) for preventing removal of the engagement portions 310, 310 to the locking portions 320, 320 side. In this manner, the engagement portions 310, 310 can be movable in the approach/separation direction T in the state where the engagement portions 310, 310 are biased to the locking portions 320, 320 side with respect to the first access member 110 by means of the biasing members 330, 330. The locking portions 320, 320 are recessed portions provided in the image forming apparatus body 101.

In addition, as illustrated in FIGS. 2 and 4, the second access member 120 can be opened and closed about a second turning axis γ2 extending along the rotation axis α1 of the fixing member 91. The second access member 120 is provided in an openable manner about the second turning axis γ2 with respect to the fixing device body 901. Specifically, a pair of engagers 901c, 901c (engagement recessed portions) is provided at both end portions in the rotation axis direction W at a lower portion on the first access member 110 side in the fixing device body 901. A pair of turning support shafts 120a, 120a is provided at the lower end portion of the second access member 120, and both end portions in the rotation axis direction W. In the second access member 120, the turning support shafts 120a, 120a respectively engage with engagers 901c, 901c in the fixing device body 901. In this manner, the second access member 120 can open and close with respect to the fixing device body 901 by turning about the second turning axis γ2 with respect to the fixing device body 901.

The first access member 110 is provided with the sliding contact portions 111, 111 (an example of the first activator) (FIGS. 6 and 11) that activate the switching members 240, 240 by making sliding contact with the switching members 240, 240 when the first access member 110 is being closed.

In the present embodiment, when the first access member 110 is turned in a closing direction M2 from the opened state in an opening direction M1 when the second access member 120 is closed in a closing direction N2, the sliding contact portions 111, 111 in the first access member 110 make sliding contact with the switching members 240, 240, thereby activating the switching members 240, 240. At this time, the switching members 240, 240 turn from the pressurization-release side to the pressurization side of the pressurization member 92 (in the drawing, an arrow L1 direction), the open-state pressurization-release surface 240d in contact with the pressing surface 220a of the pressing member 220 separates from the pressing surface 220a, and the open/closed-state pressurization surface 240c approaches the pressing surface 220a. The first access member 110 the engagement portions 310, 310 of the lock mechanism 300 approach the locking portions 320, 320 of the lock mechanism 300 provided in the image forming apparatus body 101.

When the first access member 110 is further turned in the closing direction M2, the switching members 240, 240 exceed the top dead center in the process of shifting from the open-state pressurization-release surface 240d to the open/closed-state pressurization surface 240c, the open/closed-state pressurization surface 240c comes into contact with the pressing surface 220a of the pressing member 220, and the contact of the open/closed-state pressurization surface 240c with the pressing surface 220a is maintained. The first access member 110 is locked, with the engagement portions 310, 310 of the lock mechanism 300 locked to the locking portions 320, 320 of the lock mechanism 300 provided in the image forming apparatus body 101.

In this manner, the image forming apparatus 100 can set the pressurization member 92 from the pressurization-release state to the pressurization state by means of the switching members 240, 240 through the closing operation of the first access member 110 by the operator.

On the other hand, when the locking state of the engagement portions 310, 310 of the lock mechanism 300 with respect to the locking portions 320, 320 of the lock mechanism 300 provided in the image forming apparatus body 101 is released, the first access member 110 turns in the opening direction M1.

In the present embodiment, the second access member 120 is a conveyance guide member that guides the sheet P conveyed at the outer surface. The first access member 110 is an exterior cover member of the image forming apparatus body 101 that forms the feeding path of the sheet P (in this example, a part of the sheet inversion feeding path 17) (see FIG. 1) together with the conveyance guide member, which is the second access member 120.

With this configuration, the first access member 110 and the second access member 120 can serve also as a feeding path of the sheet P, and the first access member 110 can serve also as an exterior cover.

### Present Embodiment

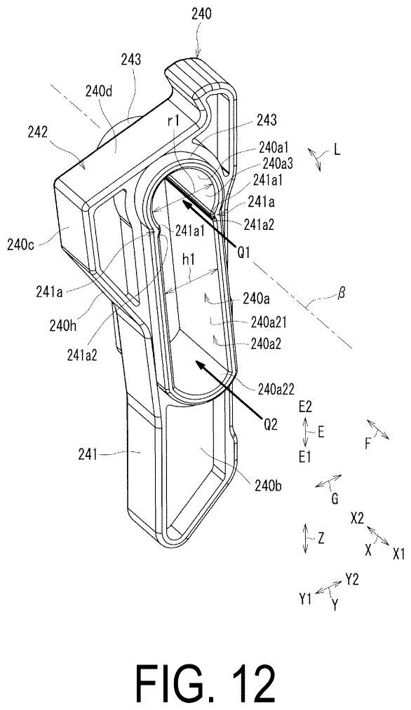

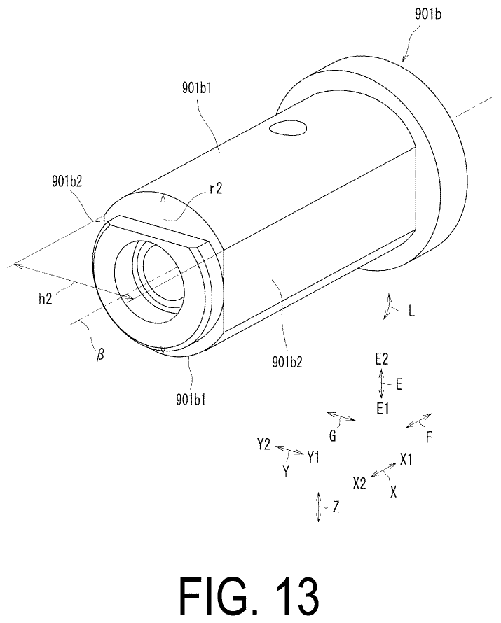

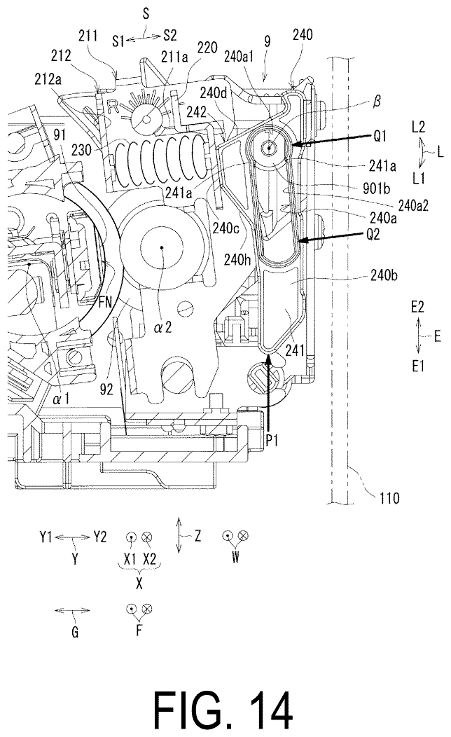

FIGS. 12 and 13 are perspective views illustrating the switching member 240 and the switching turning shaft 901b, respectively. FIGS. 14 to 16 are cross-sectional views illustrating states in which the switching member 240 is located at an open/closed-state pressurization possible position P1, an open-state pressurization-release possible position P2, and an open/closed-state pressure-release possible position Q2 in the fixing device 9, respectively.

In the present embodiment, the image forming apparatus 100 includes the fixing device 9 and the access member (in this example, the first access member 110).

As illustrated in FIGS. 14 to 16, the fixing device 9 includes the switching member 240 (240, 240) capable of switching between the pressurization state in which the pressurization member 92 is pressurized against the rotatable fixing member 91 (movement in the direction of arrow L1 in the drawing) and the pressurization-release state in which the pressurization state of the pressurization member 92 is released (movement in the direction of arrow L2 in the drawing). The access member (110) covers the fixing device 9 in a closed state and exposes the fixing device 9 in an opened state with respect to the image forming apparatus body 101 (see FIGS. 5 and 6).

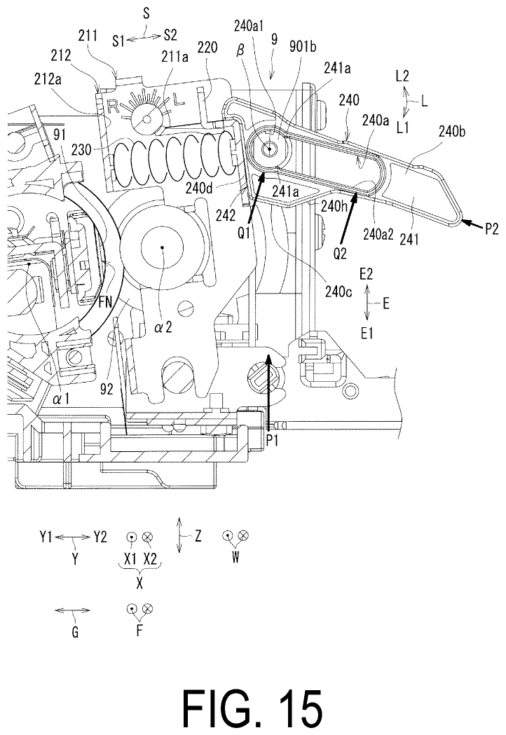

As illustrated in FIGS. 14 and 15, the switching member 240 is movable between the open/closed-state pressurization possible position P1 and the open-state pressurization-release possible position P2.

The open/closed-state pressurization possible position P1 (see FIG. 14) is a position where the pressurization member 92 can be brought into the pressurization state regardless of the opening/closing of the access member (110) (when the access member (110) is opened or closed). The open-state pressurization-release possible position P2 (see FIG. 15) is a position where the pressurization member 92 can be brought into the pressurization-release state when the access member (110) is open, but the pressurization member 92 cannot be brought into the pressurization-release state when the access member (110) is closed. In other words, the open-state pressurization-release possible position P2 is a position where the access member (110) cannot be closed when the pressurization member 92 is in the pressurization-release state.

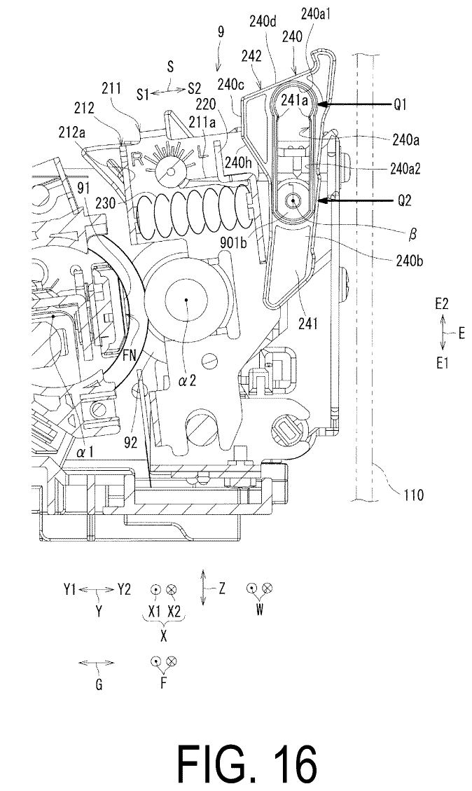

As illustrated in FIG. 16, the switching member 240 is further movable to the open/closed-state pressure-release possible position Q2 at which the pressurization member 92 can be brought into the pressurization-release state regardless of the opening and closing of the access member (110) (when the access member (110) is opened or closed).

In the present embodiment, the operator moves the switching member 240 to the open/closed-state pressure-release possible position Q2 when the pressurization member 92 is in the pressurization state. The open/closed-state pressure-release possible position Q2 is a position where the pressurization member 92 can be brought into the pressurization-release state even when the access member (110) is opened or closed by the operator, and therefore, the access member (110) can be closed with the pressurization member 92 in the pressurization-release state. That is, when the operator closes the access member (110), the pressurization member 92 can be changed from the pressurization state to the pressurization-release state. In this state, for example, the image forming apparatus 100 can be transported, or/and can be maintained in a state in which the image forming operation (printing operation) is not performed for a long period of time.

According to the present embodiment, since the switching member 240 moves to the open/closed-state pressure-release possible position Q2 regardless of the opening/closing of the access member (110), the pressurization member 92 can be brought into the pressurization-release state with respect to the fixing member 91 even when the operator closes the access member (110). Therefore, even when the image forming apparatus 100 is transported and/or stored for a long period of time during shipment, or even when the image forming apparatus 100 is maintained in a state in which an image forming operation (printing operation) is not performed for a long period of time even after installation, it is possible to avoid plastic deformation of the fixing member 91 (in this example, the fixing belt) and/or the pressurization member 92 (in this example, the pressure roller) at the fixing nip portion FN (contact portion), and thus it is possible to effectively prevent deterioration in image quality due to plastic deformation of the fixing member 91 and/or the pressurization member 92.

### First Embodiment

In the present embodiment, a switching member 240 can be returned from an open/closed-state pressure-release possible position Q2 to an open/closed-state pressurization possible position P1.

In this configuration, after the switching member 240 is located at the open/closed-state pressure-release possible position Q2, the switching member 240 can be returned from the open/closed-state pressure-release possible position Q2 to the open/closed-state pressurization possible position P1. Accordingly, the switching member 240 returned to the open/closed-state pressurization possible position P1 can be moved between the open/closed-state pressurization possible position P1 and the open-state pressurization-release possible position P2, and thus, even after the switching member 240 is located at the open/closed-state pressure-release possible position Q2, a pressurization member 92 can be switched between the pressurization state and the pressurization-release state.

### Second Embodiment

In the present embodiment, an image forming apparatus 100 further includes a switching turning shaft 901b (901b, 901b) that rotates a switching member 240 in a turning direction L about a switching turning axis β.

The switching member 240 has an elongated insertion hole 240a into which the switching turning shaft 901b is inserted so as to be slidable with respect to the switching turning shaft 901b. Accordingly, the switching member 240 can slide and move to one side E1 and the other side E2 in the sliding direction E in a state where the switching turning shaft 901b is inserted into the insertion hole 240a.

The switching member 240 is capable of turning between an open/closed-state pressurization possible position P1 (see FIG. 14) and an open-state pressurization-release possible position P2 (see FIG. 15) in a turning direction L when the switching turning shaft 901b is inserted into the insertion hole 240a and located at a predetermined turning position Q1 in the insertion hole 240a. In this example, the turning position Q1 is provided at the end of the insertion hole 240a on the other side E2 in the sliding direction E. As illustrated in FIG. 16, the open/closed-state pressure-release possible position Q2 is a position where the switching member 240 slides and moves from the turning position Q1 in the insertion hole 240a in the sliding direction E along the insertion hole 240a.

In this configuration, in a state where the switching turning shaft 901b is inserted into the insertion hole 240a of the switching member 240, the switching member 240 can be turned and moved in the turning direction L at the turning position Q1 in the insertion hole 240a, and the switching member 240 can be slid and moved in the sliding direction E from the turning position Q1. In this way, with a simple configuration using the switching turning shaft 901b, the switching member 240 can be easily turned and moved at the turning position Q1, and can be easily slid and moved from the turning position Q1 to the open/closed-state pressure-release possible position Q2.

### Third Embodiment

In the present embodiment, a switching member 240 is slidable and movable from a turning position Q1 in an insertion hole 240a to an open/closed-state pressure-release possible position Q2 when a pressurization member 92 is in a pressurization state.

In this configuration, in a state where the pressurization member 92 is in the pressurization state and a switching turning shaft 901b is inserted into the insertion hole 240a in the switching member 240, the switching turning shaft 901b can be easily slid and moved from the turning position Q1 to the open/closed-state pressure-release possible position Q2 in the insertion hole 240a.

Specifically, as illustrated in FIG. 12, the switching member 240 is an elongated member, and the insertion hole 240a is provided in a switching member body 241. The insertion hole 240a penetrates the switching member body 241 along a switching turning axis direction F (width direction X in this example). The insertion hole 240a is configured by an arc-shaped hole portion 240a1 in which on one side E1 in a sliding direction E is open and a long hole portion 240a2 in which the other side E2 in the sliding direction E is open, and an open side of the arc-shaped hole portion 240a1 and an open side of the long hole portion 240a2 communicate with each other.

As illustrated in FIG. 13, the switching turning shaft 901b has a shape in which both end portions in an orthogonal direction G (depth direction Y in this example) orthogonal to both the sliding direction E and the switching turning axis direction F in a columnar or cylindrical member are cut along the sliding direction E. The switching member 240 is capable of turning in the turning direction L about a switching turning axis β when the switching turning shaft 901b is located in the arc-shaped hole portion 240a1. The switching member 240 is reciprocally movable in the sliding direction E when the switching turning shaft 901b is located in the long hole portion 240a2.

An inner diameter r1 of the arc-shaped hole portion 240a1 is larger than an outer diameter r2 of the switching turning shaft 901b (uncut portion) by a predetermined size (size enough to allow outer peripheral surfaces 901b1, 901b1 of the switching turning shaft 901b to slide on the inner surface of the arc-shaped hole portion 240a1). A width h1 of the long hole portion 240a2 in the orthogonal direction G is larger than a width h2 of the switching turning shaft 901b (cut portion) in the orthogonal direction G by a predetermined size (size enough to allow side surfaces 901b2, 901b2 of the switching turning shaft 901b to slide on the inner surface of the long hole portion 240a2).

The inner diameter r1 of the arc-shaped hole portion 240a1 is larger than the width h1 of the long hole portion 240a2. The outer diameter r2 of the switching turning shaft 901b is larger than the width h2 of the switching turning shaft 901b.

On the outer periphery of the insertion hole 240a, a reinforcement portion 243 protruding in the switching turning axis direction F from both sides in the switching turning axis direction F is provided over the entire periphery.

### Fourth Embodiment

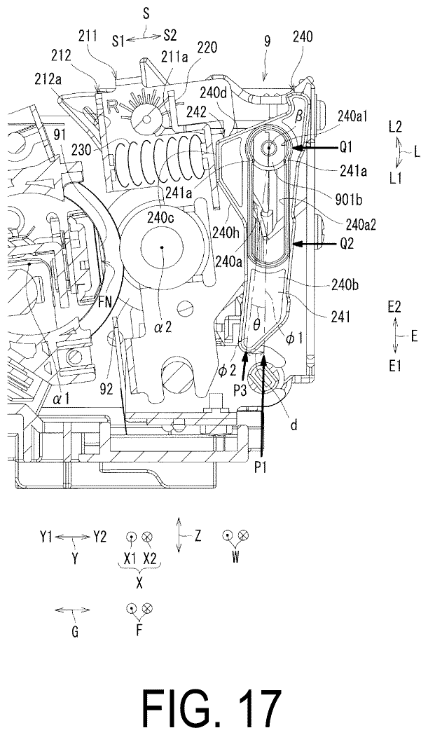

FIG. 17 is a cross-sectional view of a fixing device 9 in which a switching member 240 is located at a slidable position P3.

When the switching member 240 is located at an open/closed-state pressurization possible position P1 in a turning direction L at a turning position Q1 in an insertion hole 240a, a pressurization member 92 is in a pressurization state. If the switching member 240 is slid and moved at this time, the pressurization member 92 enters in a pressurization-release state. Therefore, the switching member 240 should not be slid and moved at the open/closed-state pressurization possible position P1.

In this regard, the switching member 240 is slidable in the sliding direction E only when the switching member 240 is located at a predetermined slidable position P3 other than the open/closed-state pressurization possible position P1 in the turning direction L in the turning position Q1 in the insertion hole 240a when the pressurization member 92 is in the pressurization state. For example, the slidable position P3 may be a position other than the open/closed-state pressurization possible position P1 and the open-state pressurization-release possible position P2.

This configuration effectively prevents the switching member 240 from sliding and moving at the open/closed-state pressurization possible position P1 where the switching member 240 should not be slid or moved.

Specifically, when the switching member 240 is located at the open/closed-state pressurization possible position P1 in the turning position Q1, the long hole portion 240a2 is inclined with respect to the sliding direction E, and when the switching member 240 is located at the slidable position P3 in the turning position Q1, the long hole portion 240a2 is along the sliding direction E.

### Fifth Embodiment

In the present embodiment, a slidable position P3 is a position where a switching member 240 is further pushed in from an open/closed-state pressurization possible position P1 by a predetermined distance d (angle θ) in a direction opposite to an open-state pressurization-release possible position P2 in a turning direction L.

In this configuration, the switching member 240 can be located at the slidable position P3 by the operator pushing the switching member 240 from the open/closed-state pressurization possible position P1 by the predetermined distance d (angle θ) in the direction opposite to the open-state pressurization-release possible position P2, and this improves the operability in moving the switching member 240 to the slidable position P3.

The angle θ formed by a first virtual line φ1 passing through the distal end of the switching member 240 located at the open/closed-state pressurization possible position P1 and a switching turning axis β and a second virtual line φ2 passing through the distal end of the switching member 240 located at the slidable position P3 and the switching turning axis β can be about 3 degrees to 10 degrees, but is not limited thereto. In this example, the angle θ is about 5 degrees.

### Sixth Embodiment

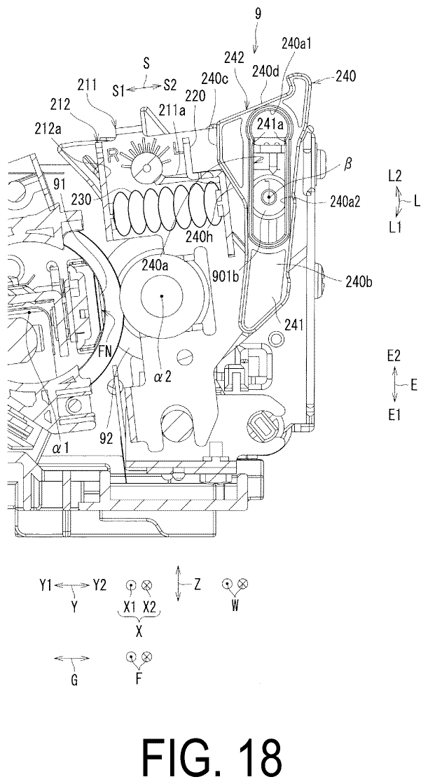

FIG. 18 is a cross-sectional view showing a state in which an inclined surface 240h of a switching member 240 is in sliding contact with a pressing member 220.

In the present embodiment, an image forming apparatus 100 further includes a support member 210 and a pressing member 220. The support member 210 supports a pressurization member 92 in a pressurization possible and pressurization-release possible manner with respect to a fixing member 91. The pressing member 220 presses the support member 210 toward the fixing member 91.

A switching member 240 has a protruding portion 242 that protrudes from a switching member body 241 toward the pressing member 220 and abuts on the pressing member 220.

The protruding portion 242 has an open/closed-state pressurization surface 240c, an open-state pressurization-release surface 240d, and the inclined surface 240h. The open/closed-state pressurization surface 240c is a surface that brings the pressurization member 92 into the pressurization state by abutting on the pressing member 220 when the switching member 240 is located at an open/closed-state pressurization possible position P1. The open-state pressurization-release surface 240d is a surface that brings the pressurization member 92 into the pressurization-release state by abutting on the pressing member 220 when the switching member 240 is located at an open-state pressurization-release possible position P2. The inclined surface 240h is a surface inclined between the open/closed-state pressurization surface 240c and the switching member body 241, and comes into sliding contact with the pressing member 220 when the switching member 240 slides and moves between a turning position Q1 and an open/closed-state pressure-release possible position Q2.

In this configuration, when the operator moves the switching member 240 between the turning position Q1 and the open/closed-state pressure-release possible position Q2, the inclined surface 240h can be brought into sliding contact with the pressing member 220, thereby allowing the switching member 240 to smoothly slide and move.

Specifically, the inclined surface 240h is inclined such that the height in an orthogonal direction G increases as the switching member 240 moves away from the upstream side to the downstream side in the direction from the turning position Q1 toward the open/closed-state pressure-release possible position Q2 (the other side E2 in a sliding direction E) between the open/closed-state pressurization surface 240c and the switching member body 241.

In this example, the pressing member 220 is supported by the support member 210 so as to be movable in an approach/separation direction S of the pressurization member 92. The image forming apparatus 100 further includes a biasing member 230. The biasing member 230 is disposed between the support member 210 and the pressing member 220 and biases the pressing member 220 in a separation direction S2 in the approach/separation direction S. The protruding portion 242 abuts on the pressing member 220 on the side opposite to the fixing member 91.

### Seventh Embodiment

If the switching member 240 is movable in the sliding direction E in the insertion hole 240a, the switching member 240 may slide to the open/closed-state pressure-release possible position Q1 during turning in the turning direction L at the turning position Q2.

In this regard, in the present embodiment, when a switching member 240 is located at a turning position Q1 in an insertion hole 240a, the switching member 240 is maintained at the turning position Q1 until a predetermined external force is applied, and when an external force exceeding the predetermined external force is applied, the switching member 240 is slidable from the turning position Q1 to an open/closed-state pressure-release possible position Q2.

In this way, it is possible to effectively prevent the switching member 240 from sliding and moving to the open/closed-state pressure-release possible position Q2 during turning in a turning direction L at the turning position Q1.

In this example, a protrusion 241a is provided at an end of a sliding contact portion 240a3 with the switching member 240 located at the turning position Q1 of the insertion hole 240a on the open/closed-state pressure-release possible position Q2 side.

In this configuration, the protrusion 241a can allow the switching member 240 to turn in a state where the sliding and movement of the switching member 240 from the turning position Q1 to the open/closed-state pressure-release possible position Q2 is restricted, and can allow the switching member 240 to slide and move from the turning position Q1 to the open/closed-state pressure-release possible position Q2. In this manner, providing the protrusion 241a in the insertion hole 240a makes it possible to easily implement a configuration in which the switching member 240 is maintained at the turning position Q1 until a predetermined external force is applied when being located at the turning position Q1 in the insertion hole 240a, and slides and moves from the turning position Q1 to the open/closed-state pressure-release possible position Q2 when an external force exceeding the predetermined external force is applied.

Specifically, the protrusion 241a includes first arc portions 241a1, 241a1 extending from both ends of an arc-shaped hole portion 240a1 on one side E1 in the sliding direction E, and second arc portions 241a2, 241a2 extending from both ends of a long hole portion 240a2 on the other side E2 in the sliding direction E.

The first arc portions 241a1, 241a1 have the same curvature radius as the arc-shaped hole portion 240a1. The second arc portions 241a2, 241a2 are connected to the first arc portion 241a1, and the orientation of the arcs of the second arc portions 241a2, 241a2 is opposite to the orientation of the arcs of the first arc portions 241a1, 241a1. The second arc portions 241a2, 241a2 have the same curvature radius as the arc-shaped hole portion 240a1.

The long hole portion 240a2 has a slide portion 240a21 along the sliding direction E and a third arc portion 240a22 connected to an end of the slide portion 240a21 on one side E1 in the sliding direction E. The orientation of the arc of the third arc portion 240a22 is opposite to the orientation of the arc of the arc-shaped hole portion 240a1. The third arc portion 240a22 has the same curvature radius as the arc-shaped hole portion 240a1.

### Other Embodiments

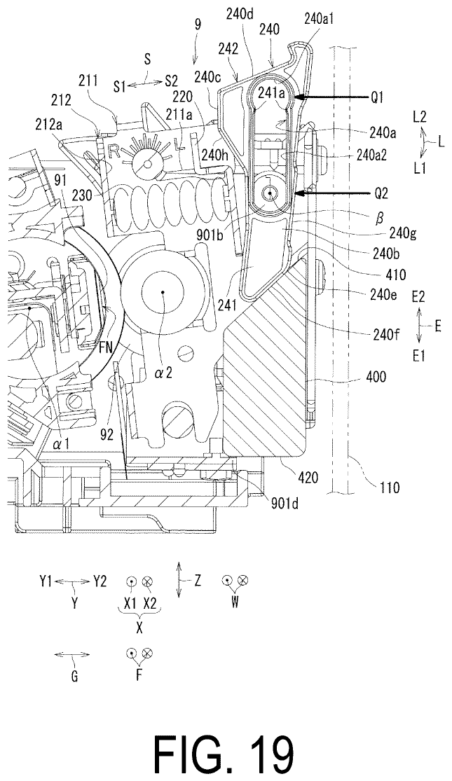

FIG. 19 is a cross-sectional view illustrating a state in which a fixing member 400 is inserted between a switching member 240 and a bottom plate 901d of a fixing device 9.

In a case where the switching member 240 is located at an open/closed-state pressure-release possible position Q2, when an image forming apparatus 100 is moved for transportation of the image forming apparatus 100 or the like, the switching member 240 may rattle.

In this regard, in the present embodiment, the fixing member 400 for fixing the switching member 240 located at the open/closed-state pressure-release possible position Q2 is provided when the image forming apparatus 100 is moved. The fixing member 400 is inserted between the switching member 240 and the bottom plate 901d of the fixing device 9. The fixing member 400 is removed when the image forming apparatus 100 is installed. In this example, the fixing member 400 is configured with a packing member, and can be formed of a packing material such as a corrugated cardboard material or a foam material.

Specifically, in levers 240b of the switching members 240, 240, an access member (110) side is inclined at an obtuse angle at a bent portion 240e, and an inclined surface 240f and a side surface 240g are connected with the bent portion 240e therebetween. The fixing member 400 has an inclined surface 410 that comes into contact with the inclined surfaces 240f of the switching member 240, 240 and a bottom surface 420 that comes into contact with the bottom plate 901d of the fixing device 9 when being attached to inside of a fixing device body 901.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An image forming apparatus comprising:
a fixing device that includes a switching member capable of switching between a pressurization state in which a pressurization member is pressurized against a rotatable fixing member and a pressurization-release state in which the pressurization state of the pressurization member is released; and
an access member that covers the fixing device in a closed state and exposes the fixing device in an opened state, wherein
the switching member is movable between an open/closed-state pressurization possible position where the pressurization member is capable of being in the pressurization state regardless of opening/closing of the access member, and an open-state pressurization-release possible position where the pressurization member is capable of being in the pressurization-release state when the access member is open but is not capable of being in the pressurization-release state when the access member is closed, and
the switching member is further movable to an open/closed-state pressure-release possible position at which the pressurization member is capable of being in the pressurization-release state regardless of opening/closing of the access member.

2. The image forming apparatus according to claim 1, wherein the switching member is capable of returning from the open/closed-state pressure-release possible position to the open/closed-state pressurization possible position.

3. The image forming apparatus according to claim 1, further comprising a switching turning shaft that turns the switching member in a turning direction about a switching turning axis, wherein
the switching member has an elongated insertion hole into which the switching turning shaft is inserted so as to be slidable and movable with respect to the switching turning shaft, and is capable of turning between the open/closed-state pressurization possible position and the open-state pressurization-release possible position in the turning direction when the switching turning shaft is inserted into the insertion hole and located at a predetermined turning position in the insertion hole, and
the open/closed-state pressure-release possible position is a position to which the switching member is slid and moved from the turning position in the insertion hole in a sliding direction along the insertion hole.

4. The image forming apparatus according to claim 3, wherein the switching member is slidable and movable from the turning position in the insertion hole to the open/closed-state pressure-release possible position when the pressurization member is in the pressurization state.

5. The image forming apparatus according to claim 3, wherein the switching member is slidable and movable in the sliding direction only when the switching member is located at a predetermined slidable position other than the open/closed-state pressurization possible position in the turning direction at the turning position in the insertion hole with the pressurization member in the pressurization state.

6. The image forming apparatus according to claim 5, wherein the slidable position is a position where the switching member is further pushed in from the open/closed-state pressurization possible position by a predetermined distance in a direction opposite to the open-state pressurization-release possible position in the turning direction.

7. The image forming apparatus according to claim 3, further comprising:
a support member that supports the pressurization member so as to be able to pressurize and release the pressurization with respect to the fixing member; and
a pressing member that presses the support member toward the fixing member, wherein the switching member has a protruding portion that protrudes from a switching member body and abuts on the pressing member, and
the protruding portion has an open/closed-state pressurization surface that abuts on the pressing member to bring the pressurization member into the pressurization state when the switching member is located at the open/closed-state pressurization possible position, an open-state pressurization-release surface that abuts on the pressing member to bring the pressurization member into the pressurization-release state when the switching member is located at the open-state pressurization-release possible position, and an inclined surface that is inclined between the open/closed-state pressurization surface and the switching member body, and
the inclined surface comes into sliding contact with the pressing member when the switching member slides and moves between the turning position and the open/closed-state pressure-release possible position.

8. The image forming apparatus according to claim 3, wherein the switching member is maintained at the turning position until a predetermined external force is applied when the switching member is located at the turning position in the insertion hole, and is slidable and movable from the turning position to the open/closed-state pressure-release possible position when an external force exceeding the predetermined external force is applied.

9. The image forming apparatus according to claim 8, wherein a protrusion is provided at an end portion of a sliding contact portion with the switching member located at the turning position of the insertion hole on the open/closed-state pressure-release possible position side.
